(19) United States
(12) Patent Application Publication
(10) Pub. No.: US 2014/0129821 A1
(43) Pub. Date: May 8, 2014

(54) TEST SYSTEM AND METHOD FOR COMPUTER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: BO TIAN, Shenzhen (CN); KANG WU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/065,476

(22) Filed: Oct. 29, 2013

(30) Foreign Application Priority Data
Nov. 6, 2012 (CN) 2012104372269

(51) Int. Cl. G06F 9/44

(52) U.S. Cl. CPC G06F 9/4416
USPC 713/2

(57) ABSTRACT

A test system for a computer includes a basic input/output system (BIOS) chip, a platform controller hub (PCH) chip, and a baseboard management controller (BMC) chip. The PCH chip performs a test on a component of the computer according to a control instruction outputted by the BIOS chip to determine an operation state of the component. The PCH chip outputs state signals to the BMC chip through a corresponding general purpose input output (GPIO) pin according to a test result of the component. The BMC chip obtains test information according to the state signals received from the corresponding GPIO pin.

### BACKGROUND

1. Technical Field

The present disclosure relates to a test system for a computer.

2. Description of Related Art

A computer needs to be tested to determine whether or not the computer operates normally in different environments. For example, the computer is placed in a cabinet where humidity and temperature are changeable to determine whether or not the computer can be bootstrapped in various conditions. However, it is inconvenient to determine whether or not the computer malfunctions. Furthermore, it is difficult to determine which parts of the computer malfunction.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a test system for a computer of the present disclosure, wherein the test system is coupled to a client and includes a basic input/output system (BIOS) chip, a platform controller hub (PCH) chip, and a basic management controller (BMC) chip.

FIG. 2 is a block diagram of the BIOS chip, the PCH chip, and the BMC chip of FIG. 1.

FIG. 3 is a flow chart of an embodiment of a test method for a computer of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean ‘at least one’.

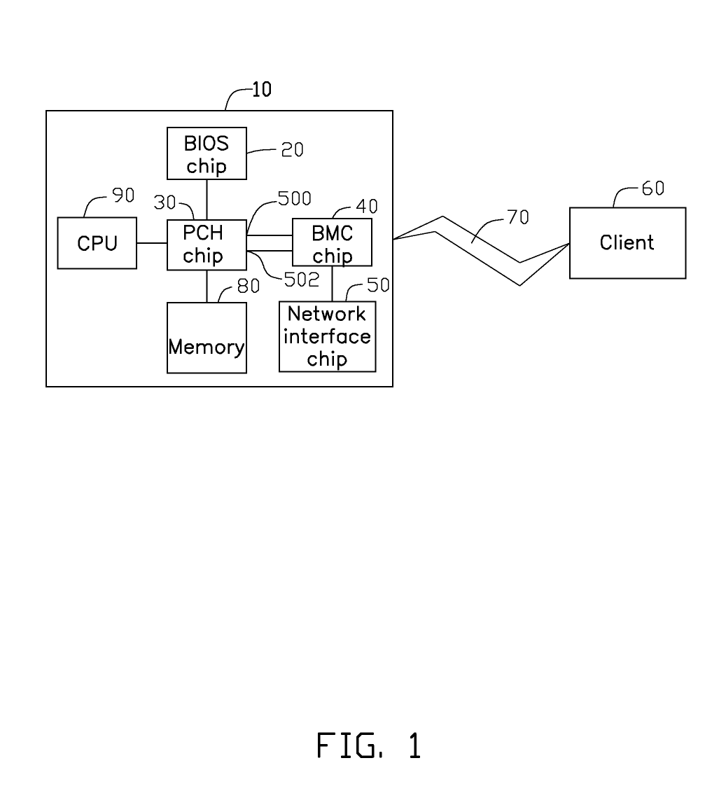

FIG. 1 illustrates an embodiment of a test system for a computer 10. The test system is configured to perform a test on a number of components of the computer 10 and output test results to a client 60 through a network 70. The test system includes a basic input/output system (BIOS) chip 20, a platform controller hub (PCH) chip 30, a baseboard management controller (BMC) chip 40, and a network interface chip 50. In the embodiment, the components to be tested include a central processing unit (CPU) 90 and a memory 80. The PCH chip 30 outputs state signals to the BMC chip 40 through corresponding general purpose input/output (GPIO) pins. The state signals correspond to tests performed on the components of the computer. In one embodiment, the PCH chip 30 outputs a first state signal through a first GPIO pin 500 when the CPU 90 operates normally, outputs a second state signal through the first GPIO pin 500 when the CPU chip 90 malfunctions, outputs a first state signal through a second GPIO pin 502 when the memory 80 operates normally, and outputs a second state signal through the second GPIO pin 502 when the memory 80 malfunctions. In other embodiments, the PCH chip 30 performs tests on other components, such as fans, and a number of the GPIO pins are adjusted accordingly.

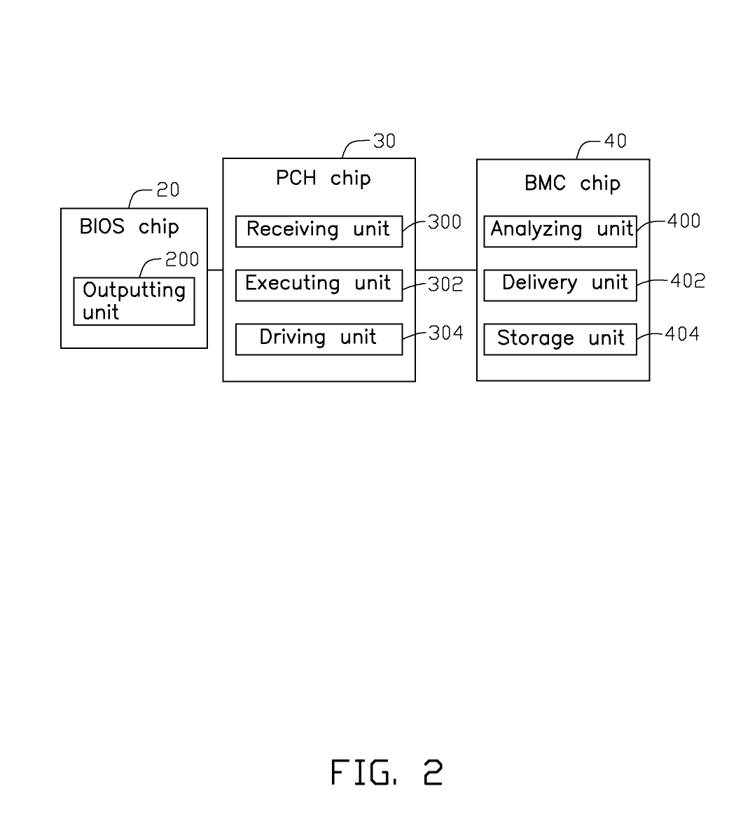

FIG. 2 shows that the BIOS chip 20 includes an outputting unit 200 and stores a plurality of programs to be executed to perform certain functions. The outputting unit 200 outputs control instructions to the PCH chip 30. The control instructions are instructions for testing components of the computer 10. For example, during the bootstrap process of the computer 10, the CPU 90 may need to be tested to determine whether or not the CPU 90 malfunctions, so the outputting unit 200 of the BIOS chip 20 outputs a first control instruction to the PCH chip 30. If the memory 80 needs to be tested, the outputting unit 200 outputs a second control instruction to the PCH chip 30.

The PCH chip 30 stores a plurality of programs to be executed to perform certain functions. The PCH chip 30 includes a receiving unit 300, an executing unit 302, and a driving unit 304. The receiving unit 300 receives the control instructions from the BIOS chip 20, and the executing unit 302 performs tests on the corresponding components according to the control instructions. For example, when the receiving unit 300 receives the first control instruction, the executing unit 302 performs a test on the CPU 90 to determine whether or not the CPU 90 operates normally, and generates the corresponding state signals. The driving unit 304 outputs the state signals through the corresponding GPIO pins. For example, when the executing unit 302 determines that the CPU 90 malfunctions, the driving unit 304 outputs the second state signal to the BMC chip 40 through the first GPIO pin 500. When the executing unit 302 determines that the memory module 80 operates normally, the driving unit 304 outputs the first state signal to the BMC chip 40 through the second GPIO pin 502.

The BMC chip 40 stores a plurality of programs to be executed to perform certain functions. The BMC chip 40 includes an analyzing unit 400, a delivery unit 402, and a storage unit 404. The storage unit 404 stores test information according to the state signals outputted from the corresponding GPIO pins. The test information include the CPU 90 malfunctioning according to the second state signal received from the first GPIO pin 500, and the memory 80 operating normally according to the second state signal received from the second GPIO pin 502.

The analyzing unit 400 receives the state signals and obtains a test result from the storage unit 404 according to the state signal outputted from the corresponding GPIO pins. For example, the analyzing unit 400 obtains the test result about the CPU 90 malfunctioning upon receiving the second state signal from the first GPIO pin 500. The analyzing unit 400 further obtains the test result about the memory 80 operating normally upon receiving the first state signal from the second GPIO pin 502. The delivery unit 402 outputs the test result to the client 60 through the network interface chip 50. Accordingly, the client 60 obtains the specific component malfunctioning as the computer 10 fails to bootstrap.

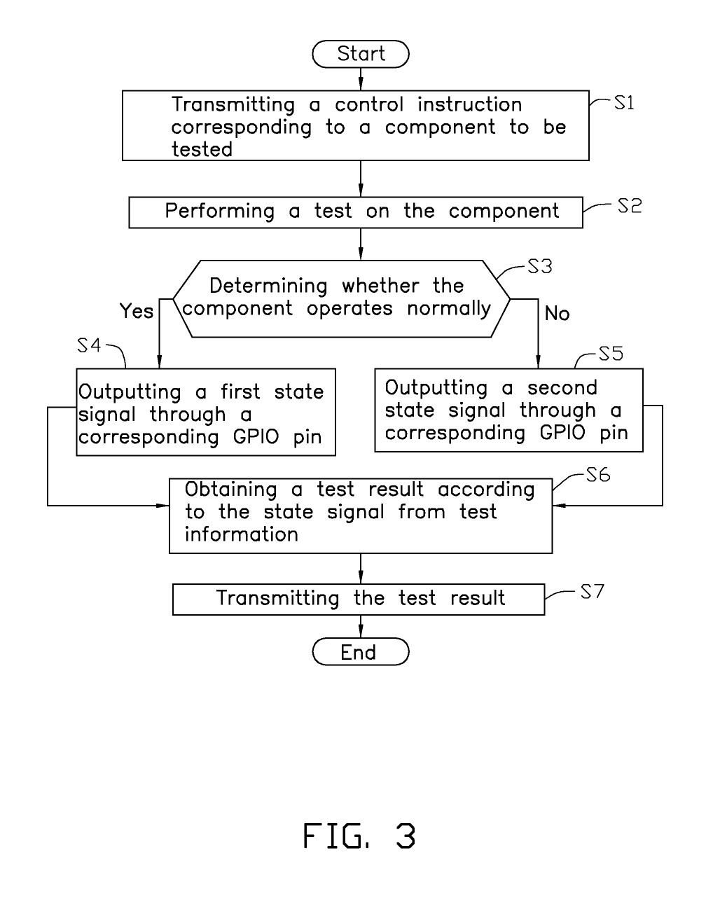

FIG. 3 shows that a test method for the computer 10 includes the following steps.

In step S1, the BIOS chip 20 outputs a control instruction corresponding to a component to be tested, such as the CPU 90 or the memory 80.

In step S2, the PCH chip 30 receives the control instruction to perform a test on the component.

In step S3, the PCH chip 30 determines whether or not the component operates normally according to the control instruction. If the component malfunctions, step S5 is implemented; otherwise, if the component operates normally, step S4 is implemented.

In step S4, the PCH chip 30 outputs the first state signal to the BMC chip 40 through the corresponding GPIO pin.

In step S5, the PCH chip 30 outputs the second state signal to the BMC chip 40 through the corresponding GPIO pin.

In step S6, the BMC chip 40 obtains a test result according to the type of state signal received from the PCH chip 30.

In step S7, the BMC chip 40 transmits the test result to the client 60.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A test system for a computer, comprising:
a basic input output system (BIOS) chip outputting control instructions corresponding to a plurality of components to be tested;
a platform controller hub (PCH) chip receiving the control instructions, and performing test on the corresponding components to determine operation of the corresponding components, wherein when the corresponding component operates normally, the PCH chip outputs a first state signal through a first general purpose input output (GPIO) pin; when the corresponding component malfunctions, the PCH chip outputs a second state signal through the first GPIO pin; and
a baseboard management controller (BMC) chip receiving the state signals, wherein the BMC chip stores test information corresponding to types of the state signals from the corresponding GPIO pin, the BMC chip obtains a test result according to the types of the state signals received from the corresponding GPIO pin, and outputs the test information.

2. The test system of claim 1, further comprising:
a network interface chip delivering the test information to a client.

3. The test system of claim 1, wherein when the operation of a central processing unit of the plurality of components malfunctions, the PCH chip outputs a first state signal to the BMC chip through the first GPIO pin; when the operation of a memory of the plurality of components malfunctions, the PCH chip outputs a second state signal to the BMC chip through a second GPIO pin.

4. The test system of claim 3, wherein the BMC chip stores the test information of the CPU operating normally corresponding to the first state signal from the first GPIO chip, the CPU malfunctioning corresponding to the second state signal from the first GPIO chip, the memory malfunctioning corresponding to the second state signal from the second GPIO chip, and the memory operating normally corresponding to the first state signal from the first GPIO chip.

5. A test method for a computer, comprising steps:
outputting a control instruction corresponding to a component to be tested of the computer by a basic input output system (BIOS) chip;
receiving the control instruction to perform a test on the component by a platform controller hub (PCH) chip;
determining whether the component operates normally or not by the PCH chip;
outputting a first state signal through a corresponding general purpose input output (GPIO) pin by the PCH chip, in response to the component operating normally;
outputting a second state signal through the corresponding GPIO pin by the PCH chip, in response to the component being malfunctioned;
obtaining a test result according to a type of the state signal from the corresponding GPIO pin by a baseboard management controller (BMC) chip from test information; and
outputting the test result to a client by the BMC chip.
